(19) United States
(12) Patent Application Publication
(10) Pub. No.: US 2013/0043683 A1
(43) Pub. Date: Feb. 21, 2013

(54) FLUID DRIVEN ENERGY CONVERSION APPARATUS AND METHOD

(71) Applicant: Vincent Genovese, Sparta, NJ (US)

(72) Inventor: Vincent Genovese, Sparta, NJ (US)

(21) Appl. No.: 13/211,536

(22) Filed: Aug. 17, 2011

(51) Int. Cl. F03B 13/00

(52) U.S. Cl. 290/54

(57) ABSTRACT

A fluid driven energy conversion apparatus uses a harmonic drive, which employs a wave generator rotatably mounted within a nested pair of annular members. The wave generator is arranged to cyclically deflect a flexible inner one of the nested pair into an outline having a circumferentially varying radial dimension, and thereby engage the outer one of the pair at one or more orbiting contact zones. A turbine can rotate one of the nested pair of the harmonic drive about a given axis. An electrical generator is coupled to and rotatably driven by the wave generator at an angular speed exceeding that of the turbine.

### BACKGROUND OF THE INVENTION

1. Field of the Invention

The present invention relates to fluid turbine apparatus and methods, and in particular, to transmissions for coupling the turbine to an electrical generator

2. Description of Related Art

Traditionally used for powering grain milling machines, the windmill is an ancient device for harnessing wind energy. Modern wind turbines have been designed for generating electricity. Known wind turbines have mounted a number of blades on a hub that is rotatably mounted at a nacelle containing an electrical generator. This entire structure will be mounted atop a tower and can pivot there azimuthally to keep the turbine blades facing upwind.

Other types of turbines include hydraulic turbines, which can be water turbines found in hydroelectric systems, or even simple paddle wheels. Other fluid turbines exist that are driven by various gasses or liquids.

To run effectively, an electrical generator ought to rotate faster than the turbine. For this reason, a speed increasing transmission is often placed between the turbine and the electrical generator. In most cases, it is desirable to run the electrical generator fast enough to produce AC power at a frequency designed to enhance efficiency. Higher speeds will be desirable even for DC generators, because electromagnetic machines usually will have smaller magnetic cores at higher angular speeds.

Frequently, an AC electrical generator will power an inverter (frequency converter) that rectifies the AC voltage and then produce a convenient output frequency. Normally this output frequency is consistent with power on the local electrical grid (e.g., 60 or 50 Hz in most regions). Even if wind-generated (or fluid-generated) electricity will not be transmitted to a larger electrical grid, many common electrical devices still require AC power in a specific frequency range in order to operate properly.

A harmonic drive is a gearing system typically employing a rigid outer annulus having internal teeth. A flexible annular member (also known as a flexspline) located within the outer annulus will often be cup-shaped and have external teeth for engaging the internal teeth of the outer annulus. A known wave generator in the form of a rotor having, for example, a pair of lobes can be fitted inside this flexible annular member to deflect it into a non-circular, oval shape (or other multi-lobed or single lobed shape). The teeth along the major axis of this oval-shaped flexspline can engage teeth on the inside of the rigid outer annulus. Only a fraction of the teeth on the inner and outer members will engage.

Taking the wave generator as a frame of reference, circulation of the flexible annular member (flexspline) on the wave generator will cause rotation of the rigid outer annulus. The flexible annular member will have fewer teeth than the rigid outer annulus, and so one cycle of the flexible annular member will rotate the rigid annulus less than 360°. If cycling of the flexible annular member is considered rotation at a positive speed (w1), the rigid outer annulus will rotate in a positive direction but at a slower speed (w2) proportional to the ratio (h) of the tooth counts (i.e., w2=h(w1)). Ratio h is the smaller tooth count divided by the larger.

If the wave generator, the original frame of reference, is actually rotating at positive speed S relative to some inertial frame of reference, the angular speed of the flexible annular member in the new reference system will be s1=w1+S and the angular speed of the outer annulus will be s2=w2+S. The overall relation will be s2−h(s1)=(1−h) S.

See also U.S. Pat. Nos. 3,668,946; 3,766,686; 4,945,293; 4,964,322; 6,439,081; and 6,953,086, as well as US Patent Application Publication Nos. 2005/0178892; 2008/0279686; 2008/0305934; 2009/0205451; and 2010/0303626.

### SUMMARY OF THE INVENTION

In accordance with the illustrative embodiments demonstrating features and advantages of the present invention, there is provided a fluid driven energy conversion apparatus. The apparatus includes a fluid driven turbine, an electrical generator, and a harmonic drive. The harmonic drive includes a wave generator and a nested pair of annular members. The nested pair includes an inner and an outer one. The inner one of the nested pair is flexible. The turbine is coupled to the harmonic drive to rotate one of the nested pair about a given axis. The wave generator is rotatably mounted within the nested pair of annular members and is sized to bring them into engagement at one or more discrete contact zones by deflecting the inner one into an outline having a circumferentially varying radial dimension. The electrical generator is coupled to and rotatably driven by the wave generator at an angular speed exceeding that of the turbine.

In accordance with another aspect of the invention, a method of converting energy is provided. The method employs a harmonic drive coupled between a fluid driven turbine and an electrical generator. The harmonic drive has a wave generator and a nested pair of annular members. The method includes the step of facing the turbine in a direction to cause them to rotate. The method also includes the step of delivering torque from the turbine to rotate one of the nested pair of annular members about a given axis. Another step is transferring torque from the wave generator to the electrical generator at an angular speed exceeding that of the turbine by allowing the wave generator to cyclically deflect an inner one of the nested pair into engagement with an outer one at one or more orbiting contact zones.

In accordance with yet another aspect of the invention, there is provided a fluid driven energy conversion apparatus. This apparatus includes a fluid driven turbine and a harmonic drive. The apparatus also includes an electrical generator adapted to deliver power to an electrical grid. The harmonic drive has a speed increasing ratio suitable for the electrical grid. The apparatus includes a frame for supporting the harmonic drive, the electrical generator, and the turbine. Also included is a tower for supporting the frame. The frame is azimuthally pivotable on the tower. The harmonic drive has a nested pair of annular members including an inner and an outer one. The turbine is coupled to the harmonic drive to rotate the outer one of the nested pair about a given axis. The outer one of the nested pair includes a rigid ring rotatably mounted about the frame. The inner one of the nested pair is flexible. The harmonic drive also includes a wave generator and a housing. The housing rotatably supports the outer one of the nested pair of annular members for rotation about the given axis. The inner one of the nested pair is affixed to the housing. The wave generator is rotatably mounted within the nested pair of annular members and is sized to bring them into engagement at one or more discrete contact zones by deflecting the inner one into an outline having a circumferentially varying radial dimension. The inner one of the nested pair is secured to the frame in order to prevent rotation relative to the given axis. The inner one of the nested pair has a plurality of external teeth. The outer one of the nested pair has a plurality of internal teeth that mesh with the external teeth at the one or more discrete contact zones. The wave generator has a rotor with at least two lobes. The rotor is journalled to the housing on one side and on the opposite side to the outer one of the nested pair. The rotor has an output shaft extending rearwardly. The outer one of the nested pair has a cup shaped portion and a forwardly extending input shaft. The electrical generator is coupled to and rotatably driven by the wave generator at an angular speed exceeding that of the turbine.

By employing apparatus and methods of the foregoing type an improved energy conversion can be achieved. In a disclosed embodiment, turbine blades are rotatably mounted at a supporting frame atop a tower (or a water turbine is mounted to communicate with a fluid channel). The turbine blades are coupled through a harmonic drive to an electrical generator. The harmonic drive is arranged as a speed increaser. Specifically, the wave generator of the harmonic drive is used as the output for driving the electrical generator. In this embodiment the turbine blades rotate the rigid outer annulus, while the flexible annular member (flexspline) is held stationary.

In this embodiment the rigid annulus is part of a cup-shaped member rotatably mounted inside a stationary cylindrical housing. This cup-shaped member has a forward coupling that is driven by the turbine blades. A flexible annular member is nested inside the rigid annulus and is affixed to the back of the cylindrical housing and thus remains stationary. A wave generator rotatably mounted inside the flexible annular member is journalled on one side to the cylindrical housing and on the opposite side to the cup-shaped member having the rigid annulus.

The wave generator shaft will extend through an opening in the floor of the flexible annular member (flexspline). The shaft driving the rigid annulus will extend in a direction opposite to the wave generator shaft.

Accordingly, the turbine will rotate the rigid annulus, which will tend to distort the stationary flexspine, causing the wave generator to rotate and drive the electrical generator. In this manner, the harmonic drive will increase the speed from the turbine based on the ratio of (a) the tooth count in the rigid annulus, to (b) the difference in the tooth count (rigid annulus versus flexspline). Accordingly, the electrical generator will be drive at a higher angular speed and will operate at efficient frequencies. This higher angular speed will be beneficial even for DC generators. Most commonly, the generator will deliver AC power, either directly or through an inverter, at a frequency consistent with the local electrical grid.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is an elevational view of a fluid driven energy conversion apparatus that implements a method, all according to principles of the present invention;

FIG. 2 is an elevational, sectional view taken along the axis of the harmonic drive of FIG. 1; and

FIG. 3 is a cross-sectional view taken along line 3-3 of FIG. 2.

### DETAILED DESCRIPTION

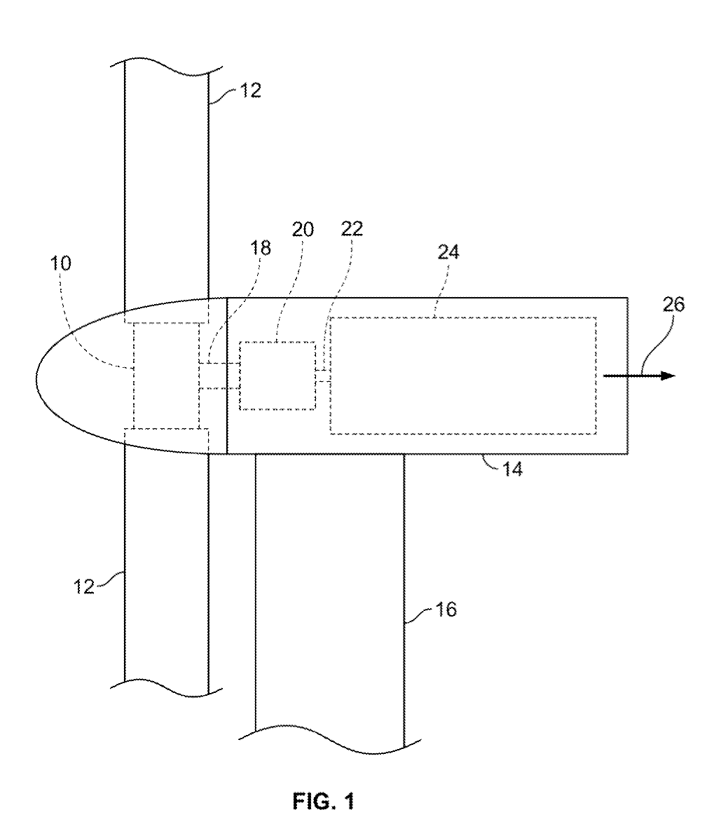

Referring to FIG. 1, a fluid driven energy conversion apparatus is shown with a hub 10 supporting turbine blades 12, which are all rotatably mounted on supporting frame 14. Blades 12 are designed to be driven by wind and are herein referred to as a fluid driven turbine (wind being considered a fluid). Frame 14 can be azimuthally pivoted on tower 16 so that blades 10 can face upwind. Hub 10 is connected to input coupling 18 of harmonic drive 20.

Harmonic drive 20 has an output shaft 22 that connects to and drives electrical generator 24. As explained further hereinafter, harmonic drive increases the angular speed applied to generator 24, allowing it to work at a higher frequency. In most cases, electrical energy at higher frequency is more easily handled, especially in electromagnetic devices where the size of a magnetic core will be affected by frequency.

Electrical generator 24 will have an AC generator that powers an inverter, which rectifies the AC voltage and then produces electrical energy at a convenient frequency. While such an inverter may be located on tower 16, in some cases, the inverter may be located at the foot of the tower, or elsewhere. In still other embodiments no inverter will be used and power from an AC or DC generator will be used directly without an intervening inverter.

In most instances, the electrical output 26 of generator 24 will be incorporated into an electrical grid or will be dedicated to powering one or more specific electrical devices. In this embodiment output 26 will be AC at a frequency consistent with the local grid, e.g. 50 or 60 Hz. However, in some embodiments output 26 may be DC power.

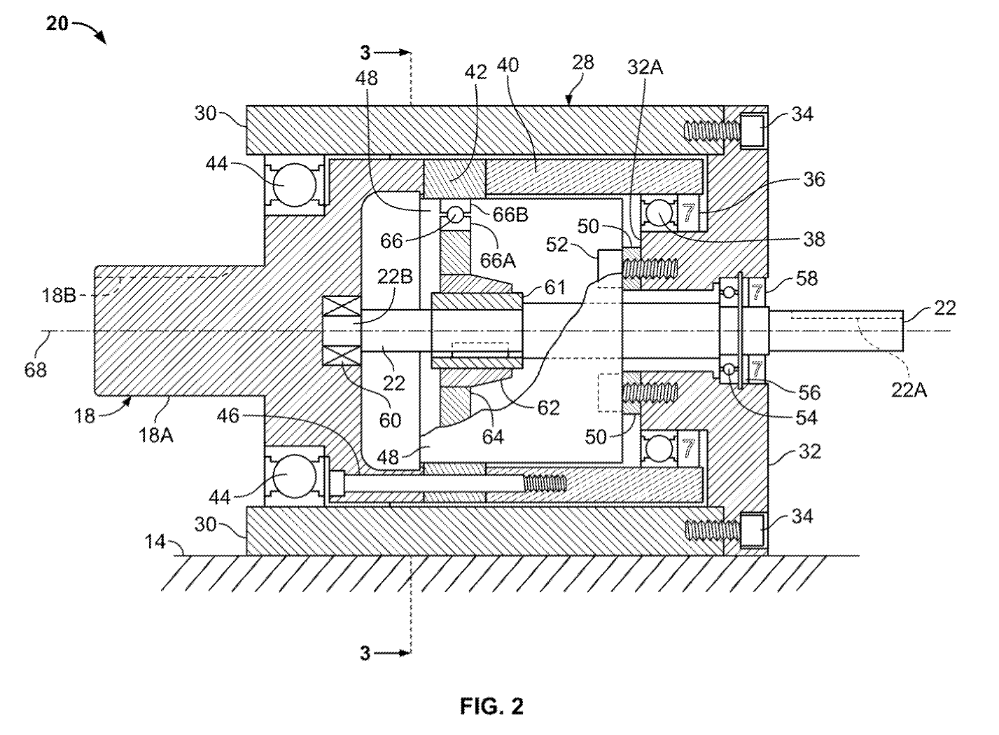

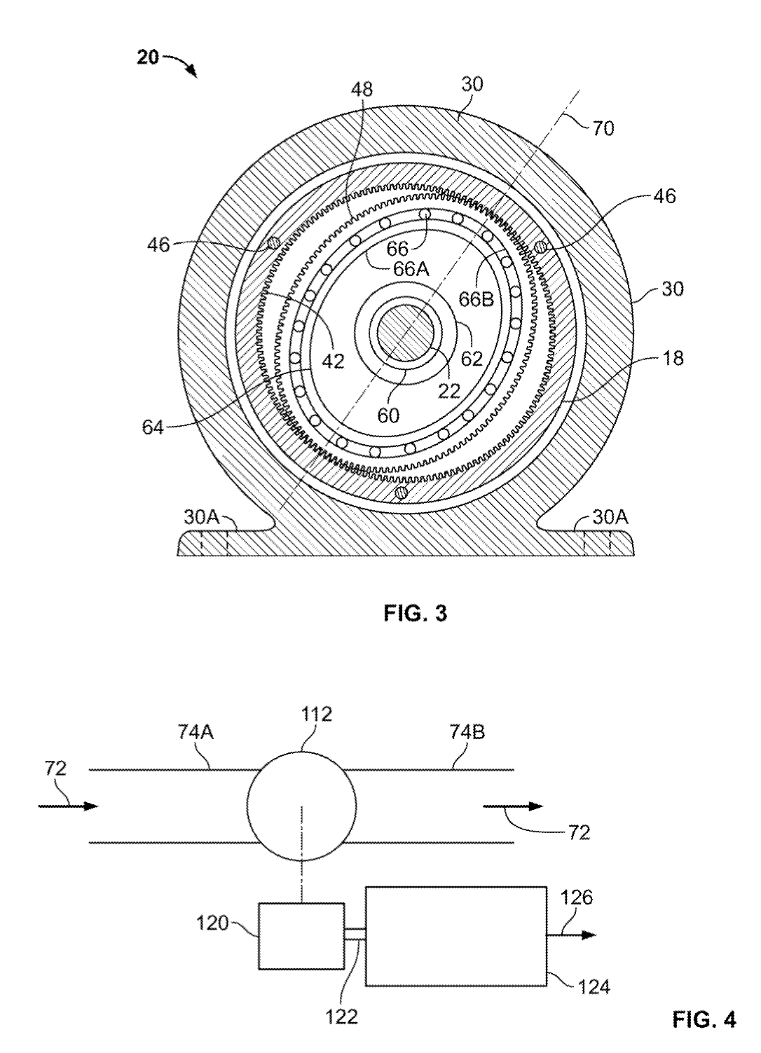

Referring to FIGS. 2 and 3, drive 20 is shown employing housing 28, composed of housing shell 30 and circular backplate 32. Shell 30 is primarily a hollow cylinder, open at both ends and formed with mounting feet 30A that are used to bolt shell 32 to the previously mentioned frame 14. Shell 30 is shown attached by bolts 34 into an annular ledge in backplate 32.

An inwardly facing, cylindrical hub 32A on backplate 32 is fitted with annular grease seal 36 (or oil seals) and ball bearings 38, although other embodiments may use angular contact bearings or roller bearings. Bearings 38 rotatably support the outer end of cylindrical sleeve 40. Rigid ring 42 is sandwiched between sleeve 40 and input coupling 18, and all three are held together by bolts 46. Coupling 18 is primarily a solid of revolution whose forward end is formed into shaft 18A having a keyway 18B. The inside end of coupling 18 has a bowl shape with an annular recess that is fitted with ball bearings 44 to engage and support rotation within previously mentioned housing shell 30.

Rigid ring 42 has a number of internal teeth designed to engage external teeth on cup-shaped flexspline 48. The base of flexspline 48 has an opening bordered by a flange 50 (open collar) that is attached to hub 32A by bolts 52 inserted through the flange.

Previously mentioned output shaft 22 is machined with a variety of diameters with the largest diameter at a midsection that passes through a complementary hole in the base of flexspline 48.

A forward portion of shaft 22 is rotatably supported in a throughbore in backplate 32 by ball bearings 54, which are encompassed by snap ring 56 and grease seal 58, although other devices may be used such angular contact bearings or roller bearings fitted with oil seals and held in place by implements other than snap rings. The rearwardmost end of shaft 22 has a reduced diameter and a keyway 22A. The forwardmost end 226 of shaft 22 has a reduced diameter and is supported in a cavity in coupling 18 by needle bearings 60.

Keyed onto shaft 22 is a collar 61 encircled by sleeve 62. Oval rotor 64 is attached on sleeve 62 and has on its perimeter, ball bearings 66, shown riding between inner race 66A and outer race 66B. Inner race 66A directly engages and conforms to the periphery of rotor 64 and outer race 66B directly engages the inside surface of flexspline 48, opposite its external teeth.

Coupling 18, rigid ring 42, sleeve 40, shaft 22 and rotor 64 all rotate about common axis 68 (also referred to as a given axis).

Flexspline 48 is nested inside rigid ring 42, and these elements 48 and 42 are herein referred to as an inner one and an outer one, respectively, of a nested pair of annular members. Rotor 64 is seen journalled on one side in housing 28 (specifically backplate 32), and on the opposite side in coupling 18, which is part of the outer one of the nested pair of annular members that includes rigid ring 42.

Rotor 64 is oval, and is mounted to drive shaft 22. Therefore, rotor 64 and bearing 66 (with races 66A and 66B) will function as a wave generator to deflect flexspline 48, which is made of relatively flexible material. Being oval, this wave generator rotor 64 effectively has two lobes, although in some embodiments a different number of lobes may be employed.

The wave generator shaft 22 will extend through an opening in the floor of flexspline 48 in one direction. The coupling 18 driving the rigid annulus 42 will extend in a direction opposite to the wave generator shaft 22. These opposing directions place the input and output on opposite sides and facilitates placement of the harmonic drive between turbine blades 12 (FIG. 1) and the electrical generator 24.

To facilitate an understanding of the principles associated with the foregoing apparatus, its operation will be briefly described. FIG. 3 may be considered the initial condition where the orientation of major axis 70 of oval rotor 64 dictates where the teeth of flexspline 48 are extended radially the most and therefore engage the teeth of rigid ring 42.

Rigid ring 42 has more teeth than flexspline 48. In this embodiment ring 42 has 160 teeth, while flexspline 48 has 158 teeth. As explained further below, this achieves a speed increasing ratio of 80:1, although it will be understood that in other embodiments different tooth counts and speed increasing ratios may be employed depending upon the generator type, desired AC frequency, etc.

Effectively, teeth on annular members 42 and 48 will mesh over two limited contacts zones at opposite ends of major axis 70. Teeth close to axis 70 will tend to be aligned while meshing teeth removed slightly from the axis will tend to be somewhat misaligned. Thus if the 160th tooth on ring 42 and the 158th tooth on flexspline 48 are aligned to mesh at one end of axis 70, at the other end of the axis, the 80th tooth on ring 42 will be aligned to mesh with the 79th tooth on flexspline 48.

Frame 14 will be azimuthally turned upwind to power turbine blades 12. Consequently, blades 12 will rotate hub 10 and input coupling 18 of harmonic drive 20. Blades 12 typically are relatively long (e.g. 10 m long) and will not rotate at a speed appropriate for generator 24. For this reason, harmonic drive 20 is arranged to act as a speed increaser offering a predetermined speed increasing ratio.

Torque generated by blades 12 will rotate input coupling 18 and rigid ring 42 as well. This rotation about axis 68 is supported by bearings 44 and 38 on housing 28 (i.e., elements 30 and 32). Housing 28 is bolted onto frame 14 through mounting feet 30A and thus will not rotate about axis 68.

The torque applied to rigid ring 42 will be transmitted to flexspline 48. However, flexspline 48 is affixed to housing 28 by bolts 52 and cannot rotate about axis 68. Instead, the applied torque will be transferred through ball bearings 66 (and races 66A and 66B) to rotor 64 which will rotate in the same direction as rigid ring 42.

Basically the teeth of ring 42 in the trailing regions of the zones of contact near axis 70 will tend to cam the trailing teeth of flexspline 48 downwardly, which tends to produces a camming action that turns rotor 64 in the same direction as ring 42.

To accommodate rotation of rigid ring 42, rotor 64 must rotate much faster. If rigid ring 42 advances the width of one tooth on flexspline 48 ( 1/158 of a turn), rotor 64 must advance the zone of contact (i.e., axis 70) to a position where the teeth of annular members 42 and 48 are again centered so that the intertooth camming force subsides.

Specifically, rotor 64 will advance 180° plus 1/158 of a turn, that is 80/158 of a turn. This translates into a speed increasing ratio of 80:1. This speed increasing ratio is based on the relative tooth counts: Specifically, the tooth count of ring 42 (160 teeth) divided by the difference in tooth counts (2 tooth difference). In operation, the major axis 70 will rotate to produce orbiting, discrete contacts zones at either end of the axis. While the foregoing describes two discrete contacts zones, other embodiments can employ a greater number of zones, or only one contact zone.

For many installations the angular speed of turbine blades 12 will be in the range of 5-20 rpm. This speed range can be narrowed by adjusting the angle of attack of the blades 12 in a conventional manner. In addition, blades 12 can be braked or even feathered in the presence of extremely strong winds. Using such techniques, and assuming adequate wind, the angular speed can be kept in a smaller range, e.g. 17 rpm (plus or minus 2 rpm). With the angular speed of blades 12 in the foregoing range, the angular speed produced by harmonic drive 20 will be in the range of 1200-1520 rpm.

Generator 24 will be designed to accommodate the angular speed from harmonic drive 20. For example, a six pole generator driven at 1200 rpm will produce AC power at 60 Hz. A four pole generator driven at 1500 rpm will produce AC power at 50 Hz. It will be understood that different angular speeds and different frequencies can be employed in other embodiments. This AC power can be used directly, but in this embodiment frequency conversion will be achieved by rectifying the AC power and driving an inverter. In a known manner the inverter can produce an AC power at a frequency that can be regulated by the inverter. In some embodiments, the inverter will produce an AC voltage synchronous with a local power grid.

Output 26 of generator 24 can be dedicated to supply power to certain electrical equipment; for example, the domestic electricity needs of a group of residences. Alternatively, the power from output 26 can be supplied to a larger grid that receives power from other turbines or from more traditional electrical power stations. When supplied to a larger grid, care will be taken to synchronize output 26 to the established phase of the grid.

Referring to FIG. 4, components corresponding to those previously described in FIGS. 1-3 bear the same reference numeral but increased by 100. In this embodiment fluid driven turbine 112 is driven by water flow 72 arriving through channel 74A and discharging through channel 74B. While water is described, it will be appreciated that fluids of various types may be employed instead, such as a variety of other liquids or gases. For example, the fluid flow can be exhaust gas from an engine, or sewage flowing through a sewer pipe.

Turbine 112 may be of the type used in a hydroelectric plant. In other embodiments of turbine 112 may be a hydraulic motor having impeller blades of various types. Channels 74A and 74B may be pipes connected to turbine 112, but in some embodiments the channels may be a free-flowing stream of water and turbine 112 a paddlewheel. In still other embodiments the fluid flow may be water flows driven by ocean waves or by tides.

The output of turbine 112 is connected to harmonic drive 120, which may be identical to the previously illustrated drive (drive 20 of FIG. 1). As before, harmonic drive 120 operates through shaft 122 to power electrical generator 124, which may be identical to the previously illustrated generator (generator 24 of FIG. 1). Generator 124 provides electrical power on line 126.

Harmonic drive 120 operates in a similar manner to that described previously in order to increase the speed from turbine 112 to shaft 122 of generator 124.

It is appreciated that various modifications may be implemented with respect to the above described embodiments. Instead of using the rigid annulus an the input drive, some embodiments may use the flexspline instead as the input drive. The component sizes and the material used will depend on the expected power, speed and torque as well as the desired strength, reliablity, etc. The foregoing bearing are exemplary and may be replaced with any one of a variety of different bearings, such as roller bearings, needle bearings, ball bearings, etc. In some cases the harmonic drive may have a cooling system to prevent overheating.

Obviously, many modifications and variations of the present invention are possible in light of the above teachings. It is therefore to be understood that within the scope of the appended claims, the invention may be practiced otherwise than as specifically described.

1. A fluid driven energy conversion apparatus, comprising:
a fluid driven turbine;
an electrical generator; and
a harmonic drive including:
(a) a nested pair of annular members including an inner and an outer one, the inner one of the nested pair being flexible, said turbine being coupled to said harmonic drive to rotate one of the nested pair about a given axis, and
(b) a wave generator rotatably mounted within said nested pair of annular members and sized to bring them into engagement at one or more discrete contact zones by deflecting the inner one into an outline having a circumferentially varying radial dimension, said electrical generator being coupled to and rotatably driven by said wave generator at an angular speed exceeding that of said turbine.

2. A fluid driven energy conversion apparatus according to claim 1 comprising:
a frame for supporting said harmonic drive, the inner one of said nested pair being secured to said frame in order to prevent rotation relative to said given axis.

3. A fluid driven energy conversion apparatus according to claim 2 comprising:
a tower for supporting said frame, said frame being azimuthally pivotable on said tower.

4. A fluid driven energy conversion apparatus according to claim 2 wherein said frame supports said electrical generator, and said turbine, the outer one of said nested pair comprising:
a rigid ring rotatably mounted about said frame.

5. A fluid driven energy conversion apparatus according to claim 1 wherein said electrical generator is adapted to deliver power to an electrical grid, said harmonic drive having a speed increasing ratio suitable for enhancing power delivery.

6. A fluid driven energy conversion apparatus according to claim 1 comprising:
a housing rotatably supporting the outer one of said nested pair of annular members for rotation about said given axis, said inner one of said nested pair being affixed to said housing.

7. A fluid driven energy conversion apparatus according to claim 6 wherein said inner one of said nested pair has a base with an opening, said wave generator having an output shaft extending rearwardly through the opening in the base of the inner one of said nested pair, the outer one of said nested pair of annular members having a forwardly extending input coupling.

8. A fluid driven energy conversion apparatus according to claim 7 wherein said inner one of said nested pair is cup-shaped, the outer one of said nested pair of annular members having a cup-shaped portion supporting said forwardly extending input coupling.

9. A fluid driven energy conversion apparatus according to claim 7 wherein said wave generator comprises:
a rotor with at least two lobes, said rotor being journalled to said housing on one side and on the opposite side to the outer one of said nested pair.

10. A fluid driven energy conversion apparatus according to claim 9 wherein the inner one of said nested pair has a plurality of external teeth, the outer one of said nested pair having a plurality of internal teeth that mesh with said external teeth at said one or more discrete contact zones.

11. A method of converting energy employing a harmonic drive coupled between a fluid driven turbine and an electrical generator, the harmonic drive having a wave generator and a nested pair of annular members, the method comprising the steps of:
facing said turbine in a direction to cause them to rotate;
delivering torque from the turbine to rotate one of the nested pair of annular members about a given axis;
transferring torque from the wave generator to the electrical generator at an angular speed exceeding that of said turbine by allowing the wave generator to cyclically deflect an inner one of the nested pair into engagement with an outer one at one or more orbiting contact zones.

12. A method according to claim 11 wherein the step of delivering torque to one of the nested pair is performed to produce rotation of the outer one of them about said given axis.

13. A method according to claim 11 wherein the harmonic drive is mounted on a supporting frame, the step of delivering torque to one of the nested pair is performed to produce rotation of one of them about said given axis, the other one of the nested pair being secured to said frame in order to avoid rotation about said given axis.

14. A method according to claim 13 comprising the step of:
azimuthally pivoting said supporting frame.

15. A method according to claim 11 comprising the step of:
delivering power from the electrical generator to an electrical grid, with said harmonic drive providing a speed increasing ratio suitable for enhancing power delivery.

16. A fluid driven energy conversion apparatus, comprising:
a fluid driven turbine;
a harmonic drive;
an electrical generator adapted to deliver power to an electrical grid, said harmonic drive having a speed increasing ratio suitable for enhancing power delivery;
a frame for supporting said harmonic drive, said electrical generator, and said turbine; and
a tower for supporting said frame, said frame being azimuthally pivotable on said tower, said harmonic drive including:
(a) a nested pair of annular members including an inner and an outer one, said turbine being coupled to said harmonic drive to rotate the outer one of the nested pair about a given axis, said outer one of said nested pair including a rigid ring rotatably mounted about said frame, the inner one of the nested pair being flexible,
(c) a housing rotatably supporting the outer one of said nested pair of annular members for rotation about said given axis, said inner one of said nested pair being affixed to said housing, and
(b) a wave generator rotatably mounted within said nested pair of annular members and sized to bring them into engagement at one or more discrete contact zones by deflecting the inner one into an outline having a circumferentially varying radial dimension, the inner one of the nested pair being secured to said frame in order to prevent rotation relative to said given axis, the inner one of said nested pair having a plurality of external teeth, the outer one of said nested pair having a plurality of internal teeth that mesh with said external teeth at said one or more discrete contact zones, said wave generator having a rotor with at least two lobes, said rotor being journalled to said housing on one side and on the opposite side to the outer one of said nested pair, said rotor having an output shaft extending rearwardly, the outer one of said nested pair having a cup shaped portion and a forwardly extending input shaft, said electrical generator being coupled to and rotatably driven by said wave generator at an angular speed exceeding that of said turbine.
